(19) United States
(12) Patent Application Publication
(10) Pub. No.: US 2008/0172343 A1
(43) Pub. Date: Jul. 17, 2008

(54) Data processing method for secure Internet transactions

(76) Inventor: Hubert JUILLET, Willer Sur Thur (FR)

Correspondence Address: BACON & THOMAS, PLLC, 625 SLATERS LANE, FOURTH FLOOR, ALEXANDRIA, VA, 22314, US

(21) Appl. No.: 12/076,463

(22) Filed: Mar. 19, 2008

Related U.S. Application Data
(63) Continuation-in-part of application No. 10/323,598, filed on Dec. 19, 2002.
Application No. 10/323,598 is a continuation-in-part of application No. PCT/FR01/01916, filed on Jun. 19, 2001.

(30) Foreign Application Priority Data
Jun. 20, 2000 (FR) 00 07840
Jan. 23, 2001 (FR) 01 00967

(51) Int. Cl. G06Q 30/00

(52) U.S. Cl. 705/76

(57) ABSTRACT

Method of processing secure online transactions such as authentication, ordering, purchasing and payment, whereby the need for any specific configuration of the Internet user's computer or the web pages of merchant sites or other sites is eliminated and only insertion of a data storage medium into said computer to carry out the online activities is needed. The data storage medium comprises an executable software that transmits the web page present on the screen of said computer along with a unique number to the issuer of said medium for authentication. After authentication by the issuer, the latter transmits an order, accompanied by said captured web page, to said merchant site.

### CROSS REFERENCE TO RELATED APPLICATION

This application is a continuation-in-part of application Ser. No. 10/323,598 filed Dec. 19, 2002, the entirety of which is incorporated herein by reference.

### BACKGROUND

A. Field

The present invention relates, by way of a novel industrial product, to a method of processing online transactions, for example online authentication, payment, ordering, and purchasing on a network like the Internet.

B. Related Art

In electronic commerce on a network like the Internet, there are two unresolved problems, which are the following:

a) During an online purchase, the Internet user must fill out a form in order to provide information such as his shipping and payment addresses. Internet users find this tiresome and risky, and they often back out when asked to fill out these forms. Some Internet merchant sites store the information provided during an initial purchase, and if the Internet user later returns to make other purchases on their sites, he does not need to communicate this information again. However, each time the user makes a purchase on a site on which he has never purchased anything, he must fill out another form, which does not solve the problem.

b) If a merchant site wishes to use the services of an outside payment provider like PAYPAL or AMERICAN EXPRESS, it must contact these providers, then install various elements on its server such as software, links, icons, or the like. In such cases, the merchant site must submit an application to a service provider and conclude merchant agreements with that provider in order to obtain this type of service. These applications and the installation of said elements are complicated for the merchant sites.

There are also known authentication solutions that use unique numbers or codes, two copies of which are generated by an issuer; the latter retains one of said copies and delivers the other copy, stored on a data storage medium, to an entity, i.e. an Internet user who is pre-identified and registered with the issuer. The Internet user stores said unique numbers on his computer, then retrieves one for each online purchase and transmits it to the merchant site in question. The merchant site then in turn transmits the unique number to the issuer for authentication.

These solutions have the drawback of requiring a complex configuration of the systems involved as well as the prior submission of an application from the merchant sites to said issuer.

The present invention makes it possible to overcome these drawbacks, and relates to a data storage medium comprising a novel piece of software.

### BRIEF DESCRIPTION OF THE DRAWINGS

The invention will be clearly understood by referring to the description below and to the attached drawings, in which:

FIG. 1 is a summary of the data processing steps disclosed in U.S. patent application Ser. No. 10/323,598 filed Dec. 19, 2002, of which this application is a continuation-in-part.

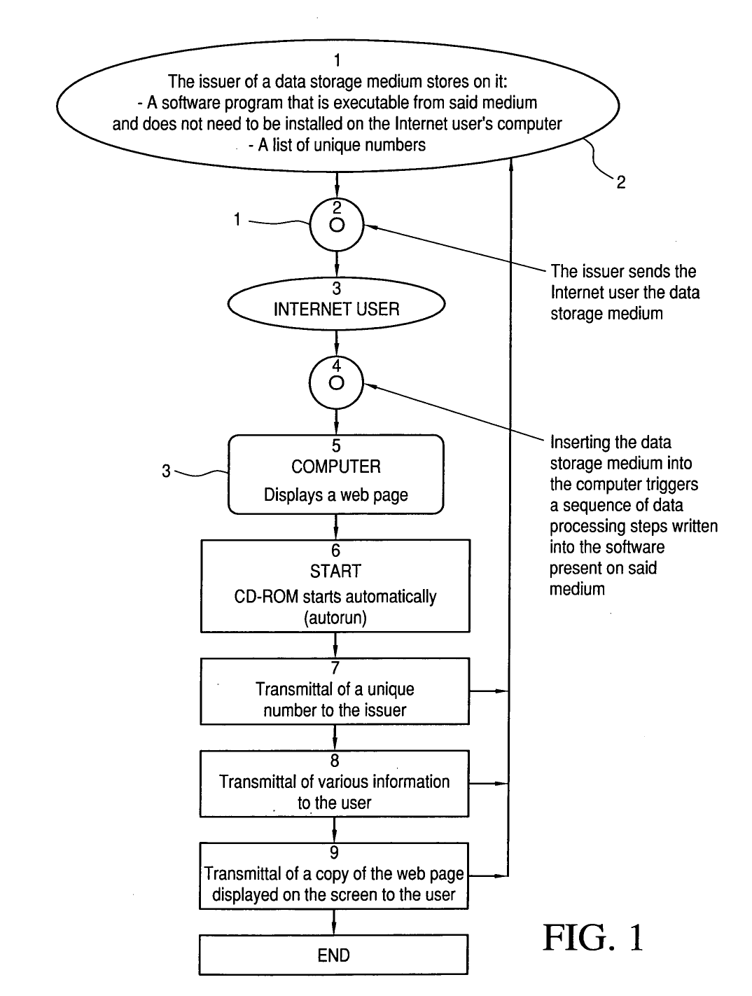

FIG. 2 represents a novel data processing step that consists of comparing the URL of a web page displayed on the screen of a computer with a list of URLs stored on a data storage medium, and if a match is found, initiating a novel sequence of dedicated or diverse data processing steps.

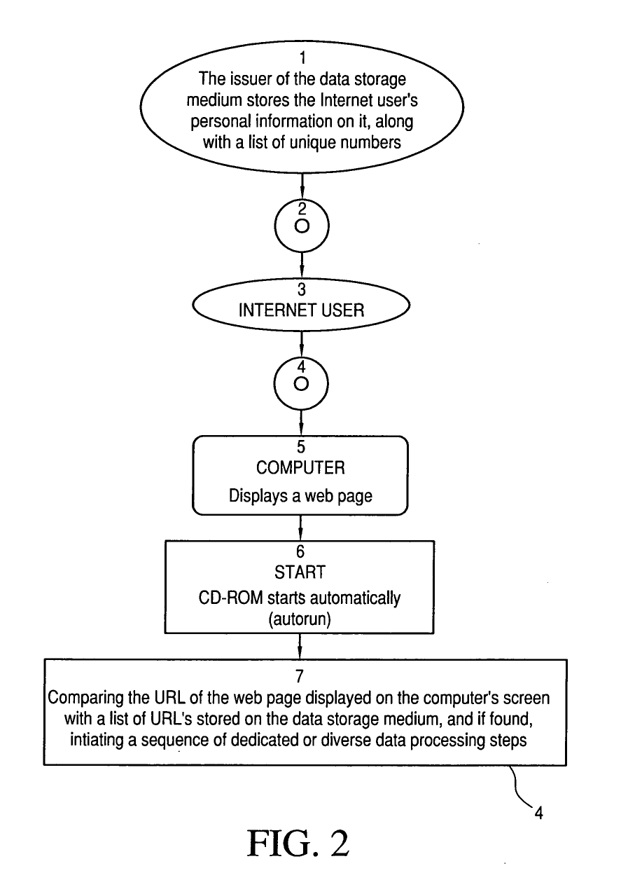

FIG. 3 represents a novel data processing step that comprises comparing the URL of a web page displayed on the screen of a computer with a list of URLs stored on a data storage medium, and if a match is not found, initiating a predetermined sequence of data processing steps.

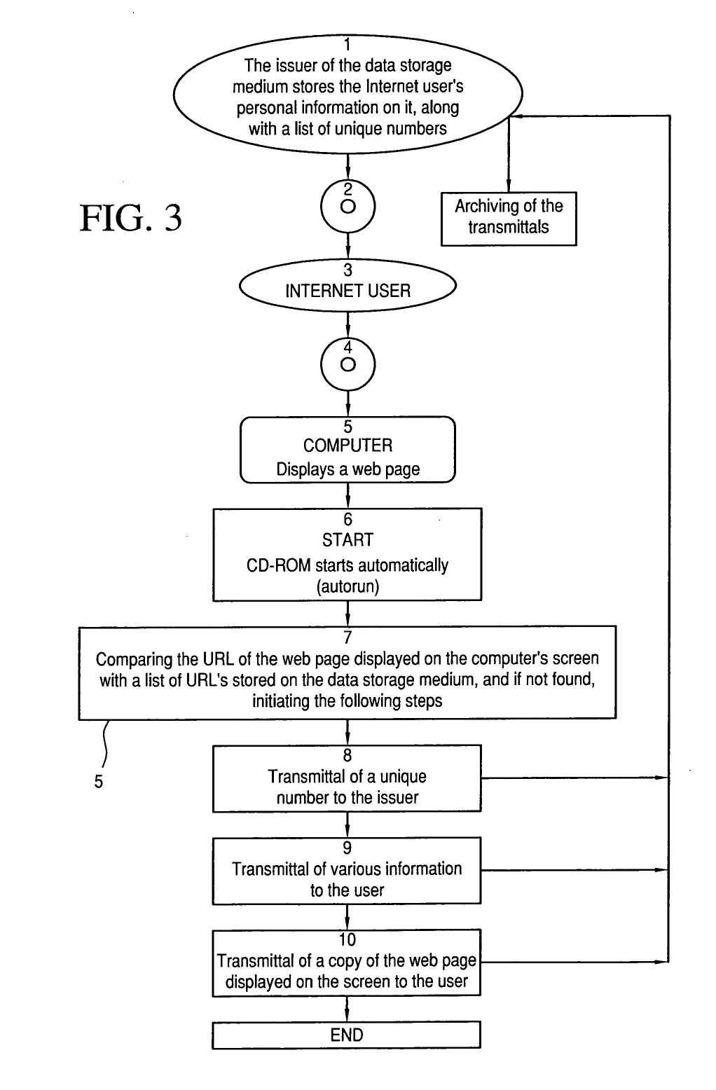

FIG. 4 represents a novel data processing step added to one described in FIG. 3, by means of which, on said computer, copies of transmittals sent via the Internet are saved, deleted, or modified.

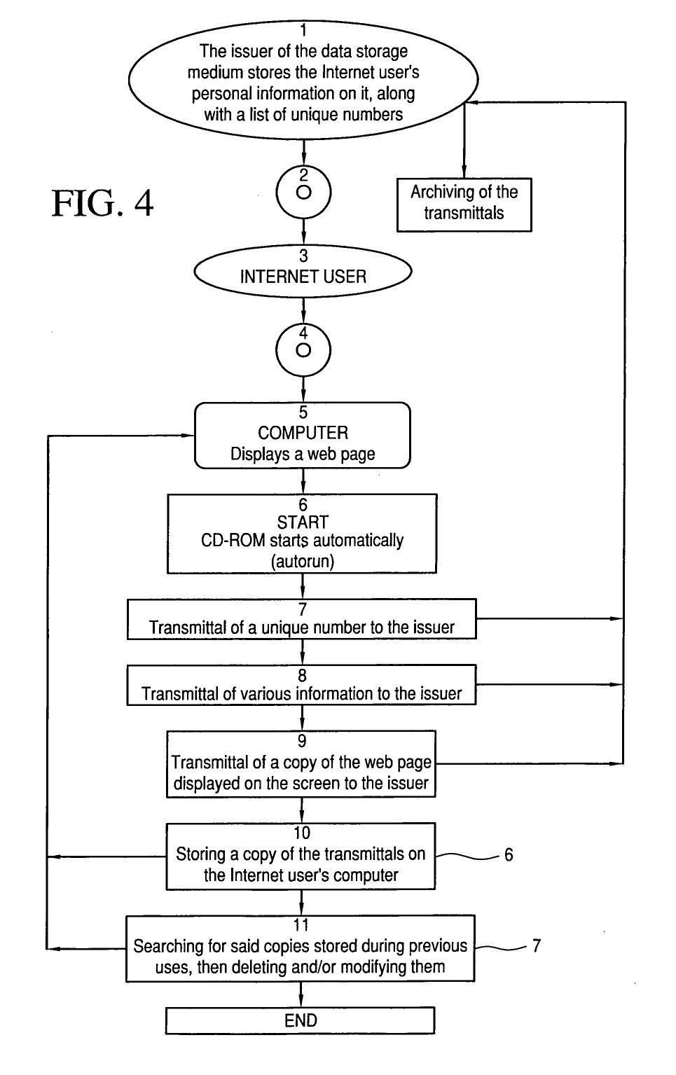

FIG. 5 represents the elements of FIG. 3 and FIG. 4 assembled into a single sequence of data processing steps.

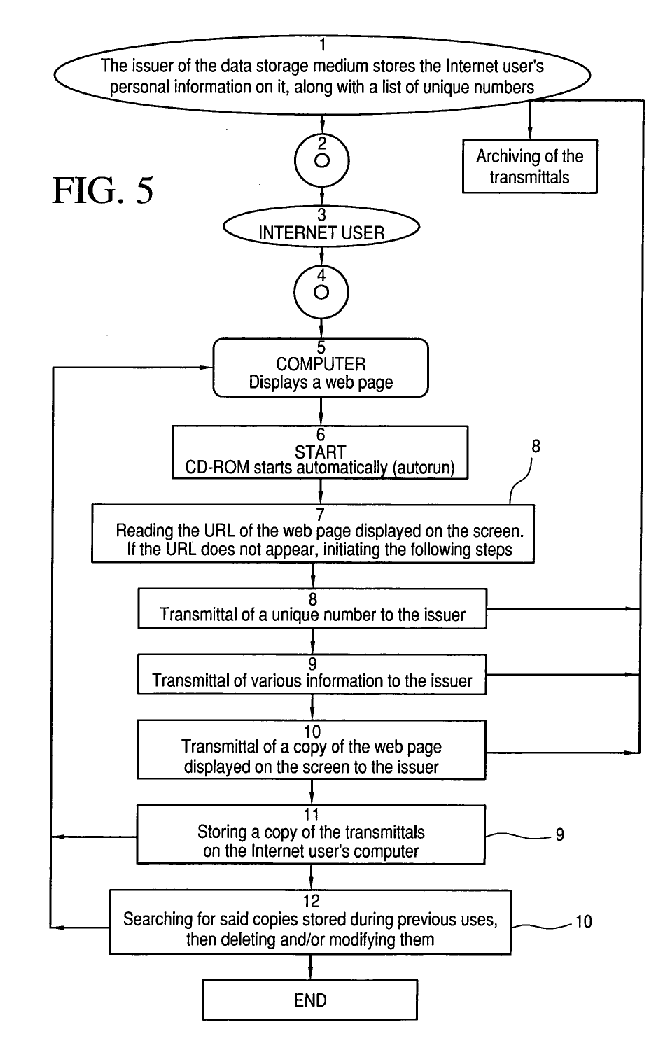

### DETAILED DESCRIPTION OF PREFERRED EMBODIMENTS OF THE INVENTION

A data storage medium 1 is sent by an issuer 2 to Internet users who have been pre-identified by the issuer. These media may be diskettes, CD-ROMs, USB keys, or other media. This data storage medium stores a piece of software that includes novel data processing steps and a list of unique numbers, a copy of which is retained by the issuer. When a web page that consists of one or more products or services for sale and their prices is displayed on the screen 3 of a computer, and the Internet user wishes to purchase these products or services, he inserts said medium into the appropriate reader of said computer. The software then either starts automatically or requires a click to start; it then copies said web page and adds one of said unique numbers and various other information to this copy, then transmits everything to said issuer. This transmittal is sent by email.

When the issuer receives this message, it authenticates it by comparing the unique number appearing therein with the copy it has retained. If the authentication is confirmed, the issuer then has access to the following elements:

the Internet user's personal information

a copy of said web page on which the product or service for sale appears.

The issuer then searches for the merchant site corresponding to said web page and, if it finds it, it contacts the site to conclude with the latter the terms of an order, its delivery, and its payment. The merchant site then has the ability to accept or reject this order.

Thus, the two problems mentioned above are solved, i.e.:

a) In placing and paying for his order, the Internet user did not have to fill out a form on the merchant site.

b) The merchant site, in executing the sale and collecting the payment, did not need to install anything on its server or on its web pages, and did not need to pre-apply to any service provider, since it was said issuer that brought it the order and its payment.

The present method makes it possible to obtain the following novel technical effects.

Said software comprises a sequence of novel data processing steps that make it possible to perform online transactions such as online authentication, and/or payment, and/or order, and/or purchase on a network like the Internet, without any human intervention other than that of inserting a data storage medium into any computer when any web page representing any product and/or any service is displayed on it, and that make it possible to perform the above functions on any web page, no matter what its configuration, without the need for the website to which said page belongs to be equipped with or to modify anything on its web page, in its computer system, or anywhere else in order to be adapted to the use of the present method, and that make it possible to perform the above functions without the need for said merchant site to be informed of the existence of the present method, and that make it possible to perform the above functions on any computer connected to a network, without the Internet user's having to be equipped with or to modify, install or store anything on his computer. These novel technical effects are obtained by storing on said data storage medium said copy of the unique numbers and a computer software program which is executable from said medium and that comprises the following sequence of novel data processing steps:

the insertion of said data storage medium into a computer

the automatic starting and running of said software stored on said data storage medium

the online transmittal to the issuer by said software stored on said data storage medium of one of said unique numbers from a list of numbers, and with each new transmittal, a new said number from said list,

the online transmittal to the issuer by said software stored on said data storage medium of various data and information, and

the online transmittal to the issuer by said software stored on said data storage medium of a copy of the web page that is displayed on the screen of said computer.

Said software is executable from said medium and runs automatically after being inserted into said computer.

Said transmittals are sent by email, and/or by webmail, or directly by a server or by any means other than the Internet, online or offline, the receiving address for said transmittal(s) being that of said issuer.

After the reception of said transmittal, said issuer compares said unique number appearing therein with the list of those of which it has copies, and validates or invalidates said reception depending on whether or not said number is recognized.

After validation, said issuer transmits a copy of said transmittal, authenticated and possibly accompanied by a means of payment, to the site to which said web page belongs. This transmittal constitutes an order.

A variant consists of dedicating a sequence of specific data processing steps to one or more Internet sites or web pages, so that said data storage medium works differently on them than it does on other, non-dedicated sites or pages. To do this, a list of URLs and/or character strings is stored on said data storage medium, and sequences of data processing steps dedicated to this URL or this character string are written into said software, one of which data processing sequences is the following:

the insertion said data storage medium into a computer

the automatic starting and running of said software stored on said data storage medium

comparing the URL and/or the character strings present on said web page displayed on the screen of said computer with the URL and/or said character strings on said data storage medium to determine if said URL and/or the character string are present on said data storage medium, and if said URL and/or said character string are found on said data storage medium (4),

initiating a sequence of data processing steps that are either diverse or dedicated to this URL or this character string stored on said data storage medium, and if said URL and/or said character string are not found (5) on said data storage medium, initiating the following sequence of novel data processing steps:

the online transmittal to the issuer by said software stored on said data storage medium of one of said unique numbers from said list of numbers, and with each new transmittal, a new said number from said list

the online transmittal to the issuer by said software stored on said data storage medium of various data and information

the online transmittal to the issuer by said software stored on said data storage medium of a copy of the web page that is displayed on the screen of said computer.

Another variant consists of storing (6) on said Internet user's computer a copy of said transmittals so he can later consult them, then delete, streamline or modify them. To do this, the following sequence of novel data processing steps is added to said data processing steps:

storing (6) at least part of the contents of the copies of said transmittals on said Internet user's computer

searching (7) for said copies or parts of copies that have been stored on said Internet user's computer during one or more previous uses of said data storage medium and deleting or modifying the elements found.

The present invention is not limited to the embodiments described above, which simply constitute exemplary applications to which various modifications may be made, without departing from its scope of the invention. Thus, this method can also include a data processing step in which said Internet user's computer disconnects from said site of said web page after said capture.

One or more data files can also be stored on said data storage medium. Said executable software may also require a click to start.

Said program can also include empty memory storage areas. At least some of said empty memory areas may need to be filled in by said Internet user or uploaded.

Said program and/or software can also include at least one access code.

A credit can be allocated to said data storage medium, thus allowing it to serve as an electronic wallet. Said captured web page can be a banner of any type.

It is also possible for said captured web page to contain all sorts of links or elements, which may or may not be able to be captured in said capture or activated by said executable software or by another means.

Said data storage medium can take many forms, such as a bank card, a smart card, a diskette, a CD-ROM, a USB key or a portable telephone. The present method can also be used to make individual purchases online. Thus, as with advertising banners on the Internet, it is possible to provide banners depicting one or more products for sale, in which case, when a banner appears, a user need only insert said data storage medium into his computer, and this medium automatically takes care of purchasing and paying for said product.

The file or files on said medium can be called, or opened, by all types of links, which can be placed on the Internet user's computer screen, on the web page of a merchant site or another site, or in an email.

Said transmittals can be sent via all types of networks using all types of protocols, such as the HTTP, SMTP or POP protocol. Various computer programs and computer languages such as Visual Basic, JavaScript or C can be used to execute the present data processing steps without departing from the scope of application of the present invention.

Lastly, all of said data processing steps described can be assembled, in whole or in part, into a sequence of single or multiple data processing steps (8), (9) and (10).

The present invention provides many advantages over the present state of the art concerning online transactions such as authentication and payment. For example:
Merchant sites must, at the present time, install interactive software on their servers, with forms to be filled in by the internet users so that the latter can identify themselves, designate the desired products, communicate their means of payment, etc.
The merchant sites obtain such software from service providers, particularly those who make use of bank cards or smart cards.
The Web pages of these sites must be arranged specifically to allow such use and numerous constraints are demanded in this respect.
The payment systems in question are very dependent on their service providers and solid agreements bind the parties.
With the present invention, these different constraints do not exist anymore.

For example:

When an internet user is surfing on the Internet and visits a Web page of a merchant site on which a product for sale is displayed, said internet user and said merchant site do not yet know each other.

If said internet user wishes to purchase said displayed product, he/she has the choice of following the purchasing instructions of said merchant site or choosing the present method.

If said internet user chooses the latter solution, he/she then simply introduces said data medium into his/her computer and nothing further is required to process the transaction.

The purchase and/or payment will be automatically performed by the executable software of said medium and in accordance with said data-processing steps, whatever the configuration of said merchant site may be.

Information is then sent to said issuer online, in accordance with said data processing steps, and the issuer processes the information as soon as it is received.

The merchant site will shortly receive from said issuer an e-mail or the like which will include an order which is displayed, accompanied or not by a payment authorization or another means for effecting payment.

The merchant site then has the choice of accepting or of refusing said order, but it will not have to take any prior step with said issuer and/or internet user to that end.

Moreover, if a merchant site wishes to limit itself to the use of the present method, it no longer needs software, a service provider, or anything else in order to effect a sale and/or to receive payment online (i.e., to complete an online transaction).

Accordingly, the merchant site is reduced to its simplest form, namely presenting simple Web pages with the products for sale and their price.

From the standpoint of security, as the unique numbers are never recorded in a memory of the internet user's computer, an intrusion into said computer by a computer hacker is without consequence on the confidential nature of said numbers.

It will be understood that this invention may be implemented in other manners that do not depart from the spirit and scope of the invention defined by the appended claim(s), in particular other manners that would constitute the full functional equivalent of the invention disclosed and claimed herein.

1. Method of processing online transactions such as authentication, payment, ordering, and purchasing on a network like the Internet; said method comprising:
providing unique signs or numbers, two copies of which are issued by an issuer, the issuer retaining one of said copies and delivering the other copy to an entity such as an Internet user who has been pre-identified and registered with said issuer, said copy delivered to said entity being stored on a data storage medium, and said data storage medium also storing a software program;
while using said medium, said entity transmits one of said unique numbers online;
said transmittal is then authenticated by comparing the unique number found therein with the copy retained by said issuer;
said software comprising a sequence of data processing steps that enable an online transaction to be performed, such as authentication, payment, ordering, and purchasing on a network like the Internet, without any human intervention other than that of inserting the data storage medium into any computer when any web page representing any product/and or any service is displayed on said page, and that make it possible to perform the above functions on any web page, no matter what its configuration, without the need for the website to which said web page belongs to be equipped with or to modify anything on its web page, in its computer system, or anywhere else in order to be adapted to the use of the recited method, and that enable performance of the above functions without the need for said merchant site to be informed of the existence of the recited method, and that enables the above functions on any computer connected to a network to be performed, without the Internet user's having to be equipped with or to modify, install or store anything on his computer, and wherein said sequence of data processing steps comprises:
the insertion of said data storage medium into a computer;
the automatic starting and running of said software stored on said data storage medium;
the online transmittal to the issuer by said software stored on said data storage medium of one of said unique numbers from said list of numbers, and with each new transmittal, a new said number from said list;
the online transmittal to the issuer by said software stored on said data storage medium of various data and information;
the online transmittal to the issuer by said software stored on said data storage medium of a copy of the web page that is displayed on the screen of said computer;
further wherein a list of URLs and/or character strings is also stored on said data storage medium,
another sequence of novel data processing steps is also added to said data storage medium, namely:
comparing the URL and/or the character strings present on said web page displayed on the screen of said computer with the URL and/or said character strings on said data storage medium to determine if said URL and/or the character string are present on said data storage medium, and if said URL and/or said character string are found on said data storage medium:
initiating a sequence of data processing steps that are either diverse or dedicated to this URL or this character string stored on said data storage medium, and if said URL and/or said character string are not found on said data storage medium, initiating the following sequence of data processing steps:
transmitting online to the issuer by said software stored on said data storage medium of one of said unique numbers from said list of numbers, and with each new transmittal, a new said number from said list;
transmitting online to the issuer by said software stored on said data storage medium various data and information;
transmitting online to the issuer by said software stored on said data storage medium a copy of the web page that is displayed on the screen of said computer;
further wherein another sequence of data processing steps is also added to said data storage medium, namely:
storing at least part of the contents of the copies of said transmittals on said Internet user's computer;
searching for said copies or parts of copies that have been stored on said Internet user's computer during one or more previous uses of said data storage medium and deleting or modifying the elements found.
